(19) United States
(12) Patent Application Publication
(10) Pub. No.: US 2011/0200857 A1
(43) Pub. Date: Aug. 18, 2011

(54) LITHIUM-ION BATTERY AND METHOD OF MANUFACTURING THE SAME

(75) Inventors: Yusuke KAGA, Fujisawa (JP); Hiroshi KIKUCHI, Zushi (JP)

(73) Assignee: Hitachi, Ltd.

(21) Appl. No.: 13/021,207

(22) Filed: Feb. 4, 2011

(30) Foreign Application Priority Data
Feb. 16, 2010 (JP) 2010-031043

(51) Int. Cl. H01M 10/36; H01M 4/26; H01M 10/28

(52) U.S. Cl. 429/94; 29/623.2; 29/623.5

(57) ABSTRACT

A lithium-ion battery whose inner short circuit can be suppressed to improve reliability, and a method of manufacturing the same are provided. A filler is coated on an end portion of a first separator and an end portion of a second separator. In this manner, when a positive electrode, the first separator, a negative electrode, and the second separator are wound, for example, an end portion of a space formed between the positive electrode and the first separator and an end portion of a space formed between the first separator and the second separator adjacent to each other can be closed by the filler. As a result, by the filler, the entering of foreign substance (more particularly, metal foreign substance) into an electrode-wound body can be prevented.

### CROSS-REFERENCE TO RELATED APPLICATION

The present application claims priority from Japanese Patent Application No. 2010-031043 filed on Feb. 16, 2010, the content of which is hereby incorporated by reference into this application.

### TECHNICAL FIELD OF THE INVENTION

The present invention relates to a lithium-ion battery and a technique of manufacturing the same. More particularly, the present invention relates to a technique effectively applied to a lithium-ion battery including an electrode-wound body obtained by winding a positive-electrode plate on which a positive-electrode active substance is coated, a separator, and a negative-electrode plate on which a negative-electrode active substance is coated, the electrode-wound body being inserted into a packaging case, and an electrolyte solution being injected inside the packaging case, and applied to a technique of manufacturing the same.

### BACKGROUND

Japanese Patent Application Laid-Open Publication No. 2004-241251 (Patent Document 1) describes a technique of, when an electrolyte solution is injected, preventing entering of a metallic foreign substance together into an electrode-wound body. More specifically, in Patent Document 1, an insulating plate having a filtering function which allows the electrolyte solution to pass through the insulating plate is provided above the electrode-wound body formed of: a positive-electrode plate; a separator; and a negative-electrode plate, which are wound. The Patent Document describes that, in the above-described manner, the entering of the metallic foreign substance can be prevented by the insulating plate when the electrolyte solution is injected.

Japanese Patent Application Laid-Open Publication No. 2009-146792 (Patent Document 2) describes a nonaqueous electrolyte secondary battery whose reliability is improved by suppressing entering of foreign substance into an electrode-wound body formed of: a positive-electrode plate; a separator; and a negative-electrode plate, which are wound. More specifically, Patent Document 2 describes a technique of adhering end portions of separators adjacent to each other which are protruded from the positive-electrode plate and the negative-electrode plate.

### SUMMARY

As the advance of mobile electronic devices, a rechargeable small-sized secondary battery has been used as a power supply source of these mobile electronic devices. More particularly, a lithium-ion battery has been remarked, the lithium-ion battery having a high energy density, a long cycle life, a low self-discharge property, and a high operating voltage. Since the lithium-ion battery has the above-described advantage point, the lithium-ion battery has been frequently used for a mobile electronic device such as a digital camera, a laptop personal computer, and a mobile phone. Further, in recent years, research and development on a large-sized lithium-ion battery that achieves high capacity, high power, and high energy density has been promoted for an electric vehicle battery or a power storage battery. More particularly, in automobile industry, in order to handle environmental problems, an electric vehicle with using a motor as a power source and a hybrid vehicle with using both an engine (internal combustion engine) and a motor as a power source have been developed. As a power supply for such an electric vehicle and hybrid vehicle, a lithium-ion battery has attracted attention.

The lithium-ion battery includes an electrode-wound body formed by winding a positive-electrode plate on which a positive-electrode active substance is coated, a negative-electrode plate on which a negative-electrode active substance is coated, and a separator for preventing contact between the positive-electrode plate and the negative-electrode plate. And, in the lithium-ion battery, the electrode-wound body is inserted into a packaging case, and an electrolyte solution is injected inside the packaging case.

A summary of steps of manufacturing the above-described lithium-ion battery will be described below. First, a positive electrode is formed by coating a positive-electrode active substance on a positive-electrode plate made of a metal foil, and a negative electrode is formed by coating a negative-electrode active substance on a negative-electrode plate made of a metal foil. Further, a separator made of a porous insulating material which prevents the contact between the positive electrode and the negative electrode and allows lithium ions to pass through the separator is prepared. Subsequently, the separator is sandwiched by the positive-electrode plate and the negative-electrode plate, and the positive-electrode plate, the separator, and the negative-electrode plate are wound. In this manner, an electrode-wound body formed of: the positive-electrode plate; the separator; and the negative-electrode plate, which are wound, is formed. Next, this electrode-wound body is inserted into a battery packaging case and fixed thereto, and the, an electrolyte solution is injected inside the packaging case. Then, the packaging case is sealed with a cap, so that the lithium-ion battery can be manufactured.

Such steps of manufacturing the lithium-ion battery includes: a step of winding the positive-electrode plate and the negative-electrode plate which are made of metal foil; a step of adhering and fixing the electrode-wound body to the packaging case; a step of injecting the electrolyte solution inside the packaging case; and others. For example, in the step of winding the positive-electrode plate and the negative-electrode plate, when the positive-electrode plate and the negative-electrode plate which are made of metal foil are wound, metal fine powder may occur. Also, in the step of adhering and fixing the electrode-wound body to the packaging case, when the electrode-wound body is adhered, metal foreign substance may disperse. Further, in the step of injecting the electrolyte solution inside the packaging case, the metal foreign substance mixed into the electrolyte solution may enter into the electrode-wound body. From the above-described view points, the steps of manufacturing the lithium-ion battery have a potential (latent possibility) such as mixture of the metal foreign substance into the electrode-wound body.

When the metal foreign substance enters into the electrode-wound body, an internal short circuit between the positive electrode and the negative electrode may occur. More specifically, a state that the metal foreign substance enters into the electrode-wound body means a state that the metal foreign substance enters into a space between the positive-electrode plate and the separator or a space between the negative-electrode plate and the separator. For example, in a case that the metal foreign substance is copper, when the copper entering into the space adheres on the positive electrode, the copper is oxidized (electrons are extracted) by a high potential of the positive electrode to be a metal ion, and is dissolved in the electrolyte solution. Then, when the metal ion reaches the negative electrode, the metal ion is reduced (electrons are supplied), and is deposited on the negative electrode as a metal (copper). If the deposition of the metal on the negative electrode due to such a mechanism is continued, the metal grown on the negative electrode reaches the positive electrode through the pores of the separator, and thus, the internal short circuit occurs between the positive electrode and the negative electrode via the deposited metal. On the other hand, in a case that the metal foreign substance is aluminum, the phenomenon of the dissolution and deposition due to oxidation-reduction reaction does not occur. However, when a size of the entering metal foreign substance is large, the metal foreign substance breaks through the separator, and thus, the internal short circuit occurs between the positive electrode and the negative electrode due to the metal foreign substance (aluminum). Once the positive electrode and the negative electrode are short-circuited therebetween, they cannot function as the lithium-ion battery. As described above, it is found out that, in the steps of manufacturing the lithium-ion battery, the metal foreign substance may occur, and the internal short circuit may occur between the positive electrode and the negative electrode by entering the caused metal foreign substance into the space between the positive-electrode plate and the separator or the space between the negative-electrode plate and the separator.

A preferred aim of the present invention is to provide a lithium-ion battery whose reliability can be improved by suppressing an internal short circuit, and a technique of manufacturing the same.

The above and other preferred aims and novel characteristics of the present invention will be apparent from the description of the present specification and the accompanying drawings.

The typical ones of the inventions disclosed in the present application will be briefly described as follows.

A lithium-ion battery according to a typical embodiment includes: (a) a positive-electrode plate on which a positive-electrode active substance containing a lithium-containing transition metal oxide is coated; (b) a negative-electrode plate on which a negative-electrode active substance containing a material to/from which lithium ions can be inserted and released is coated; (c) a separator provided between the positive-electrode plate and the negative-electrode plate; and (d) an electrolyte solution injected between the positive-electrode plate and the negative-electrode plate. And, the positive electrode, the separator, and the negative-electrode plate are wound. Here, a filler closes an end portion of a space formed between the positive-electrode plate and the separator and an end portion of a space formed between the adjacent separators to each other.

Also, a lithium-ion battery according to another typical embodiment includes: (a) a positive-electrode plate on which a positive-electrode active substance containing a lithium-containing transition metal oxide is coated; (b) a negative-electrode plate on which a negative-electrode active substance containing a material to/from which lithium ions can be inserted and released is coated; (c) a separator provided between the positive-electrode plate and the negative-electrode plate; and (d) an electrolyte solution injected between the positive-electrode plate and the negative-electrode plate. And, the positive electrode, the separator, and the negative-electrode plate are wound. Here, a filler closes an end portion of the space formed between the negative-electrode plate and the separator and an end portion of the space formed between the adjacent separators to each other.

Further, a method of manufacturing a lithium-ion battery according to a typical embodiment includes: (a) a step of forming a positive-electrode plate on which a positive-electrode active substance containing a lithium-containing transition metal oxide is coated; and (b) a step of forming a negative-electrode plate on which a negative-electrode active substance containing a material to/from which lithium ions can be inserted and released is coated. The method also includes: (c) a step of preparing a separator; (d) a step of winding the positive-electrode plate, the separator, and the negative-electrode plate; and (e) a step of, after the step of (d), closing an end portion of a space formed between the positive-electrode plate and the separator, an end portion of a space formed between the negative-electrode plate and the separator, and an end portion of a space formed between the adjacent separators to each other by a filler. Further, the method includes: (f) a step of, after the step of (e), inserting an electrode-wound body formed of the wounded positive-electrode plate, separator, and negative-electrode plate into a packaging case and fixing the same thereto; (g) a step of, after the step of (f), injecting an electrolyte solution inside the packaging case; and (h) a step of, after the step of (g), sealing the packaging case.

Still further, a method of manufacturing a lithium-ion battery according to another typical embodiment includes: (a) a step of forming a positive-electrode plate on which a positive-electrode active substance containing a lithium-containing transition metal oxide is coated; and (b) a step of forming a negative-electrode plate on which a negative-electrode active substance containing a material to/from which lithium ions can be inserted and released is coated. And, the method also includes: (c) a step of preparing a separator; (d) a step of coating a filler on an end portion of the separator; and (e) a step of, after the step of (d), winding the positive-electrode plate, the separator, and the negative-electrode plate. Further, the method also includes: (f) a step of, after the step of (e), inserting an electrode-wound body formed of the wounded positive-electrode plate, separator, and negative-electrode plate into a packaging case and fixing the same thereto; (g) a step of, after the step of (f), injecting an electrolyte solution inside the packaging case; and (h) a step of, after the step of (g), sealing the packaging case. Here, in the step of (e), the filler closes an end portion of a space formed between the positive-electrode plate and the separator, an end portion of a space formed between the negative-electrode plate and the separator, and an end portion of a space formed between the adjacent separators to each other.

The effects obtained by typical aspects of the present invention will be briefly described below.

Reliability can be improved by suppressing internal short circuit.

### BRIEF DESCRIPTIONS OF THE DRAWINGS

FIG. 1 is a diagram illustrating a schematic configuration of a lithium-ion battery;

FIG. 2 is a cross-sectional view illustrating an internal structure of a cylindrical lithium-ion battery;

FIG. 3 is a view illustrating components in a previous stage, which configure an electrode-wound body;

FIG. 4 is a schematic view illustrating a state that an electrode-wound body is formed by winding a positive electrode, a separator, and a negative electrode;

FIG. 5 is an enlarged view of a part of an electrode-wound body according to a first embodiment of the present invention;

FIG. 6 is another enlarged view of apart of an electrode-wound body according to the first embodiment of the present invention;

FIG. 7 is a view illustrating a step of manufacturing a lithium-ion battery according to the first embodiment;

FIG. 8 is a view illustrating a step of manufacturing the lithium-ion battery, continued from FIG. 7;

FIG. 9 is a view illustrating a step of manufacturing the lithium-ion battery, continued from FIG. 8;

FIG. 10 is a view illustrating a step of manufacturing the lithium-ion battery, continued from FIG. 9;

FIG. 11 is a view illustrating a step of manufacturing a lithium-ion battery according to the first embodiment;

FIG. 12 is a view illustrating a step of manufacturing a lithium-ion battery according to the first embodiment;

FIG. 13 is a view illustrating a step of manufacturing a lithium-ion battery according to the first embodiment;

FIG. 14 is a view illustrating a step of manufacturing a lithium-ion battery according to the first embodiment;

FIG. 15 is a view illustrating a step of manufacturing the lithium-ion battery, continued from FIG. 14;

FIG. 16 is a view illustrating a step of manufacturing the lithium-ion battery, continued from FIG. 15;

FIG. 17 is a view illustrating a step of manufacturing the lithium-ion battery, continued from FIG. 16;

FIG. 18 is a view illustrating a step of manufacturing the lithium-ion battery, continued from FIG. 17;

FIG. 19 is a view illustrating a step of manufacturing the lithium-ion battery, continued from FIG. 18;

FIG. 20 is a flowchart illustrating a flow of steps of manufacturing the lithium-ion battery according to the first embodiment;

FIG. 21 is a table exemplifying materials to be open-cell foam;

FIG. 22 is a table showing methods of filling (coating) phenolic resin, urea resin, and polyurethane resin;

FIG. 23 is a flowchart illustrating a flow of steps of manufacturing a lithium-ion battery according to a second embodiment; and

FIG. 24 is a table showing a material which can be sprayed.

### DETAILED DESCRIPTION

In the embodiments described below, the invention will be described in a plurality of sections or embodiments when required as a matter of convenience. However, these sections or embodiments are not irrelevant to each other unless otherwise stated, and the one relates to the entire or a part of the other as a modification example, details, or a supplementary explanation thereof.

Also, in the embodiments described below, when referring to the number of elements (including number of pieces, values, amount, range, and the like), the number of the elements is not limited to a specific number unless otherwise stated or except the case where the number is apparently limited to a specific number in principle. The number larger or smaller than the specified number is also applicable.

Further, in the embodiments described below, it goes without saying that the components (including element steps) are not always indispensable unless otherwise stated or except the case where the components are apparently indispensable in principle.

Similarly, in the embodiments described below, when the shape of the components, positional relation thereof, and the like are mentioned, the substantially approximate and similar shapes and the like are included therein unless otherwise stated or except the case where it is conceivable that they are apparently excluded in principle. The same goes for the numerical value and the range described above.

Also, components having the same function are denoted by the same reference symbols throughout the drawings for describing the embodiments, and the repetitive description thereof is omitted. Note that hatching is used even in a plan view so as to make the drawings easy to see.

### First Embodiment

Lithium has an oxidation-reduction potential of −3.03 V (vs. NHE), and is the basest metal existing on the Earth. Since a voltage of a battery is determined depending on a potential difference between a positive electrode and a negative electrode, by using lithium as a negative-electrode active substance, the highest electromotive force can be obtained. Further, since an atomic weight of lithium is 6.94 and a density thereof is 0.534 g/cm³, both of which are small, a weight per unit electric quantity thereof is small, and an energy density thereof is high. Therefore, by using lithium as the negative-electrode active substance, a small-sized and lightweight battery can be manufactured.

As described above, although lithium is an attractive substance as a negative-electrode active substance for a battery, there arises a problem when lithium is used as a rechargeable secondary battery. That is, by repeating charge and discharge in a battery in which lithium is used for a negative electrode, a discharge reaction due to dissolution of lithium and a charge reaction due to deposition of lithium are caused. In this case, since the deposition reaction of lithium is caused by the repetitive charge, there arise problems in performance degradation of the secondary battery or a safety thereof. For example, lithium generated in the charge step reacts with a solvent of the electrolyte solution on an active surface, and apart of the reaction is consumed to form a film called solid electrolyte interface (SEI). Therefore, an internal resistance of the battery is increased, and also discharge efficiency thereof is decreased. That is, for each cycle repetition of charge and discharge, a battery capacity is reduced. Further, when the battery is rapidly charged, lithium is deposited as a needle-like and dendrite-like crystal (lithium dendrite), and the deposition causes various troubles in the secondary battery. For example, lithium dendrite may accelerate the reduction of current efficiency due to a side reaction because of a large specific surface area, and may break through the separator because of the needle-like shape to cause the internal short circuit between the positive electrode and the negative electrode. By such a state, this cannot be used as a battery due to the large self discharge, or gas blowout or ignition may occur by heat due to the internal short circuit. From the above-described view points, it is found out that the performance degradation or safety problem occurs in the secondary battery with using lithium for the negative electrode.

Accordingly, a new type of a secondary battery with using a principle different from the conventional principle of dissolution and deposition has been studied. More specifically, a secondary battery with using an active substance to/from which lithium ions are inserted and released for both the positive electrode and the negative electrode has been studied. In charge and discharge steps of this secondary battery, the phenomenon of dissolution and deposition of lithium does not occur, and only phenomenon of insertion and desorption of lithium ions between electrode active substances occurs. This type of the secondary battery is called “rocking-chair” type or “shuttlecock” type, and has stable characteristics because only the phenomenon of insertion and desorption of lithium ions occurs in the repetitive charge and discharge. This type of the battery is called lithium-ion battery in this specification. As described above, in the lithium-ion battery, structures of both the positive electrode and the negative electrode are not changed by the charge and discharge, and only the phenomenon of insertion and desorption of the lithium ions occurs (note that a crystal lattice of the active substance is expanded and shrunk by the insertion and desorption of the lithium ions). Therefore, the lithium-ion battery has the cycle characteristics with remarkable long life and remarkable high safety characteristics because of not using metallic lithium for the electrodes.

Here, the material to/from which the lithium ions can be inserted and desorbed is used as the active substance for the electrodes, and conditions required for the active substance are as follows. That is, since lithium ions having limited sizes are inserted and desorbed, a site (location) where the lithium ions should be contained and a channel (path) where the lithium ions can diffuse are required for the active substance. Further, in the active substance, introduction of electrons into the material by the insertion (storage) of the lithium ions is required.

As such a positive-electrode active substance which satisfies the above-described conditions, a lithium-containing transition metal oxide is cited. For example, lithium cobalt oxide, lithium nickel oxide, lithium manganese oxide, and others can be cited as typical positive-electrode active substances. However, the active substance is not limited to them. More specifically, the positive-electrode active substance is a material to/from which lithium can be inserted and desorbed, may be a lithium-containing transition metal oxide to which a sufficient amount of lithium is previously inserted, and may be a material mainly containing a single transition metal such as manganese (Mn), nickel (Ni), cobalt (Co), and iron (Fe) or these two- or more-type transition metals as the transition metal. Also, a crystal structure such as a spinel crystal structure or layered crystal structure is not specifically limited as long as the above-described site and channel are secured. Further, a material in which a part of the transition metal or lithium in the crystal is substituted by an element such as Fe, Co, Ni, Cr, Al, or Mg, or a material in which an element such as Fe, Co, Ni, Cr, Al, or Mg is doped into the crystal may be used as the positive-electrode active substance.

Further, as the negative-electrode active substance which satisfies the above-described conditions, a crystalline carbon material or an amorphous carbon material can be used. Note that the negative-electrode active substance is not limited to these substances, and a carbon material such as natural graphite, various artificial graphite materials, and coke may be used. And, also for a particle shape of the negative-electrode active substance, various particle shapes such as a scale-like shape, a spherical shape, a fibrous shape, or a massive shape can be applied.

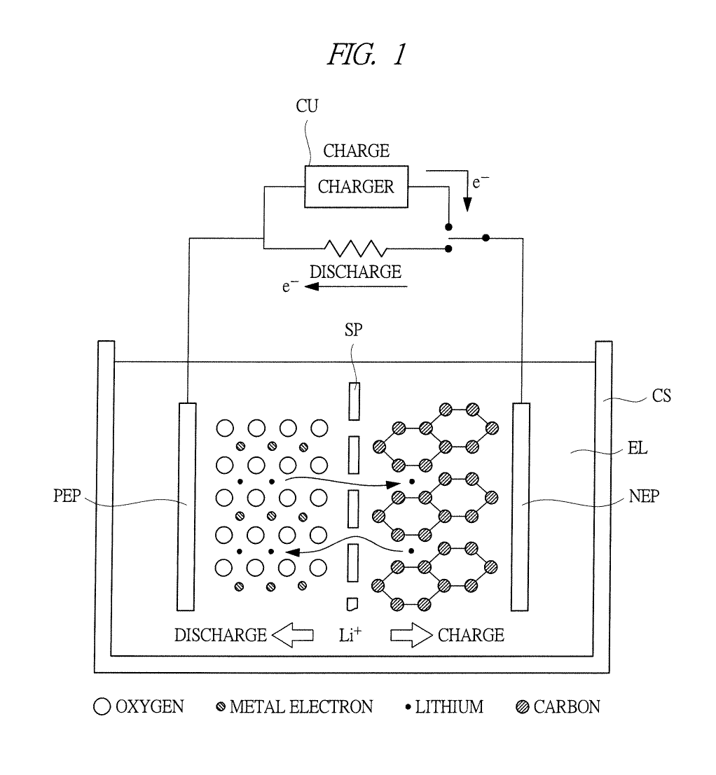

Hereinafter, a schematic configuration of the above-described lithium-ion battery will be described below with reference to the drawings. FIG. 1 is a diagram illustrating a schematic configuration of the lithium-ion battery. In FIG. 1, the lithium-ion battery has a packaging case CS, and the electrolyte solution EL is filled inside the packaging case CS. In the packaging case CS in which the electrolyte solution EL is filled, a positive-electrode plate PEP and a negative-electrode plate NEP are oppositely provided to each other, and a separator SP is disposed between the positive-electrode plate PEP and negative-electrode plate NEP that are oppositely provided to each other.

And, the positive-electrode active substance is coated on the positive-electrode plate PEP, and the negative-electrode active substance is coated on the negative-electrode plate NEP. For example, the positive-electrode active substance is formed from the lithium-containing transition metal oxide to/from which lithium ions can be inserted and desorbed. FIG. 1 schematically illustrates a state that the lithium-containing transition metal oxide is coated on the positive-electrode plate PEP. That is, FIG. 1 illustrates a schematic crystalline structure in which oxygen, metal atoms, and lithium are arranged as the lithium-containing transition metal oxide coated on the positive-electrode plate PEP. The positive electrode is composed of the positive-electrode plate PEP and the positive-electrode active substance.

On the other hand, for example, the negative-electrode active substance is formed from a carbon material to/from which lithium ions can be inserted and desorbed. FIG. 1 schematically illustrates a state that this carbon material is coated on the negative-electrode plate NEP. That is, FIG. 1 illustrates a schematic crystalline structure in which carbons are arranged as the carbon material coated on the negative-electrode plate NEP. The negative electrode is composed of the negative-electrode plate NEP and the negative-electrode active substance.

The separator SP has a function as a spacer which prevents electric contact between the positive electrode and the negative electrode and allows lithium ions to pass through the separator. In recent years, as this separator SP, a high-strength and thin microporous film has been used. This microporous film also has a function to prevent abnormal current, rapid increase in inner pressure or temperature, or ignition due to the short circuit of the battery. That is, the current separator SP has the function which prevents the electric contact between the positive electrode and the negative electrode and allows lithium ions to pass through the separator, and besides, the function as a thermal fuse for preventing the short circuit and overcharge. By the shutdown function of the microporous film, the safety of the lithium-ion battery can be maintained. For example, in a case that external short circuit occurs in the lithium-ion battery for some reasons, large current is flown in a moment, and therefore, there is a risk of abnormal temperature increase due to Joule heat. At this time, if the microporous film is used as the separator SP, holes (miropores) of the microporous film are closed at a vicinity of the melting point of the material of the film, and therefore, the permeation of lithium ions between the positive electrode and the negative electrode can be prevented. In other words, by using the microporous film as the separator SP, the current is shut at the external short circuit, so that the temperature increase inside the lithium-ion battery can be stopped. The separator SP formed of the microporous film can be formed of, for example, polyethylene (PE), polypropylene (PP), or combination of these materials.

As the electrolyte solution EL, a nonaqueous electrolyte solution is used. The lithium-ion battery is a battery in which charge and discharge are performed with using the insertion and desorption of lithium ions in the active substance, and the lithium ions move in the electrolyte solution EL. Lithium is a strong reducing agent, and drastically reacts with water to generate hydrogen gas. Therefore, in the lithium-ion battery in which lithium ions move in the electrolyte solution EL, an aqueous solution cannot be used as the electrolyte solution EL, unlike a conventional battery. Accordingly, in the lithium-ion battery, a nonaqueous solution is used as the electrolyte solution EL. More specifically, as an electrolyte of the nonaqueous electrolyte solution EL, LiPF₆, LiClO₄, LiAsF₆, LiBF₄, LiB(C₆H₅)₄, CH₃SO₃Li, CF₃SO₃Li, a mixture of these materials, or others can be used. Further, as an organic solvent, ethylene carbonate, dimethyl carbonate, propylene carbonate, diethyl carbonate, 1,2-dimethoxyethane, 1,2-diethoxyethane, γ-butyrolactone tetrahydrofuran, 1,3-dioxolane, 4-methyl-1,3-dioxolane, diethyl ether, sulfolane, methyl sulfolane, acetonitrile, propionitrile, a mixed solution of these materials, or others can be used.

The lithium-ion battery is configured as described above, and a mechanism of charge and discharge will be described below. First, the mechanism of charge will be described. As illustrated in FIG. 1, when the lithium-ion battery is charged, a charging unit CU is connected between the positive electrode and the negative electrode. In this case, in the lithium-ion battery, the lithium ions inserted inside the positive-electrode active substance are desorbed and released into the electrolyte solution EL. At this time, by desorbing the lithium ions from the positive-electrode active substance, electrons are flown from the positive electrode to the charging unit. And, the lithium ions released into the electrolyte solution EL move in the electrolyte solution EL to reach the negative electrode through the separator SP made of the microporous film. The lithium ions reaching the negative electrode are inserted into the negative-electrode active substance configuring the negative electrode. At this time, by inserting the lithium ions into the negative-electrode active substance, the electrons are flown into the negative electrode. In this manner, the electrons move from the positive electrode to the negative electrode via the charging unit, so that the charge is completed.

Subsequently, the mechanism of discharge will be described. As illustrated in FIG. 1, an external load is connected between the positive electrode and the negative electrode. Then, the lithium ions inserted into the negative-electrode active substance are desorbed and released into the electrolyte solution EL. At this time, the electrons are released from the negative electrode. And, the lithium ions released into the electrolyte solution EL move in the electrolyte solution EL to reach the positive electrode through the separator SP made of the microporous film. The lithium ions reaching the positive electrode are inserted into the positive-electrode active substance configuring the positive electrode. At this time, by inserting the lithium ions into the positive-electrode active substance, the electrons are flown into the positive electrode. In this manner, the electrons move from the negative electrode to the positive electrode, so that the discharge is performed. In other words, a current flows from the positive electrode to the negative electrode, so that the load is driven. As described above, in the lithium-ion battery, by inserting and desorbing the lithium ions between the positive-electrode active substance and the negative-electrode active substance, the charge and discharge can be performed.

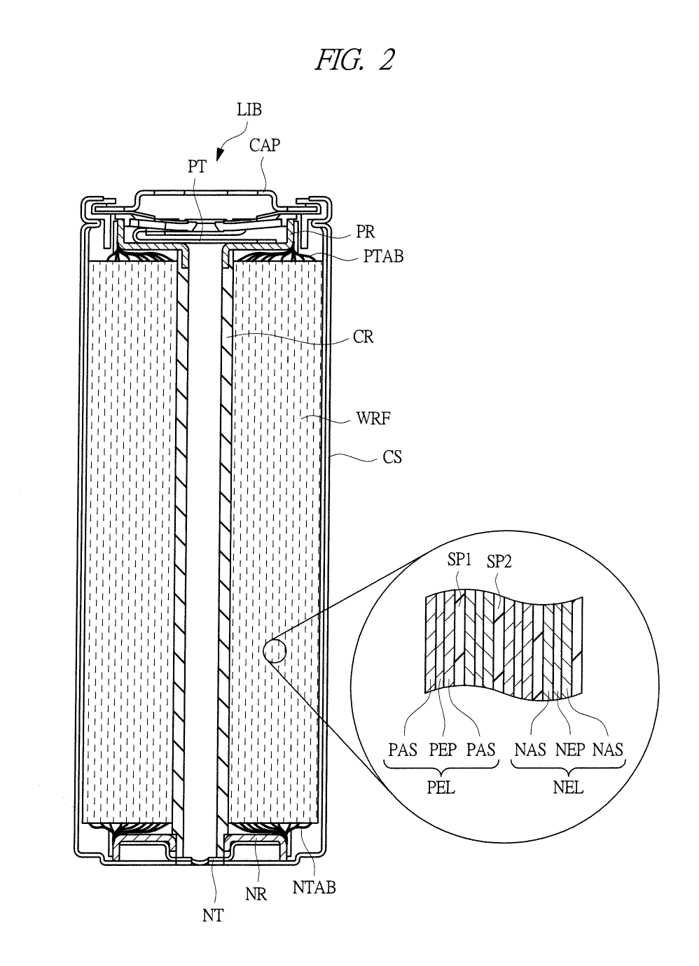

Next, a configuration example of an actual lithium-ion battery LIB will be described. FIG. 2 is a cross-sectional view illustrating an internal structure of the cylindrical lithium-ion battery LIB. As illustrated in FIG. 2, inside a bottomed-cylindrical packaging case CS, an electrode-wound body WRF composed of: a positive electrode PEL; separators SP1 and SP2; and a negative electrode NEL is formed. More specifically, in the electrode-wound body WRF, the positive electrode PEL and the negative electrode NEL are stacked on each other so as to interpose the separator SP1 (SP2) therebetween, and they are wound around a center core CR positioned at a central portion of the packaging case CS. And, the negative electrode NEL is electrically connected with a negative-electrode lead plate NT provided on a bottom portion of the packaging case CS, and the positive electrode PEL is electrically connected with a positive-electrode lead plate PT provided on a top portion of the packaging case CS. The electrolyte solution is injected inside the electrode-wound body formed inside the packaging case CS. And, the packaging case CS is closed by a battery cap CAP.

The positive electrode PEL is formed by coating a coating liquid containing a positive-electrode active substance PAS and a binder on the positive-electrode plate (positive-electrode collecting body) PEP, drying the same, and then, applying a pressure to the same. A plurality of rectangular positive-electrode collecting tabs PTAB are formed on a top end portion of the positive electrode PEL, and the plurality of positive-electrode collecting tabs PTAB are welded to a positive-electrode collecting ring PR. And, the positive-electrode collecting ring PR is electrically connected with the positive-electrode lead plate PT. Therefore, the positive electrode PEL is electrically connected with the positive-electrode lead plate PT via the positive-electrode collecting tabs PTAB and the positive-electrode collecting ring PR. The plurality of positive-electrode collecting tabs PTAB are provided for achieving low resistance of the positive electrode PEL and rapid current extraction.

As the positive-electrode active substance PAS configuring the positive electrode PEL, for example, the above-described materials represented by lithium cobalt oxide, lithium nickel oxide, lithium manganese oxide, or others, can be used. Also, as the binder, for example, polyvinyl fluoride, polyvinylidene fluoride, polytetrafluoroethylene, or others can be used. Further, as the positive-electrode plate, for example, a metal foil or a net-shape metal made of a conductive metal such as aluminum can be used.

The negative electrode NEL is formed by coating a coating liquid containing the negative-electrode active substance NAS and a binder on the negative-electrode plate (negative-electrode collecting body) NEP, drying the same, and applying a pressure to the same. A plurality of rectangular negative-electrode collecting tabs NTAB are formed on a bottom end portion of the negative electrode NEL, and the plurality of negative-electrode collecting tabs NTAB are welded to a negative-electrode collecting ring NR. And, the negative-electrode collecting ring NR is electrically connected with the negative-electrode lead plate NT. Therefore, the negative electrode NEL is electrically connected with the negative-electrode lead plate NT via the negative-electrode collecting tabs NTAB and the negative-electrode collecting ring NR.

As the negative-electrode active substance NAS configuring the negative electrode NEL, for example, the above-described materials represented by a carbon material or others can be used. As the binder, for example, polyvinylidene fluoride, polytetrafluoroethylene, or others can be used. Further, as the negative-electrode plate, for example, a metal foil or a net-shape metal made of a conductive metal such as copper or others can be used.

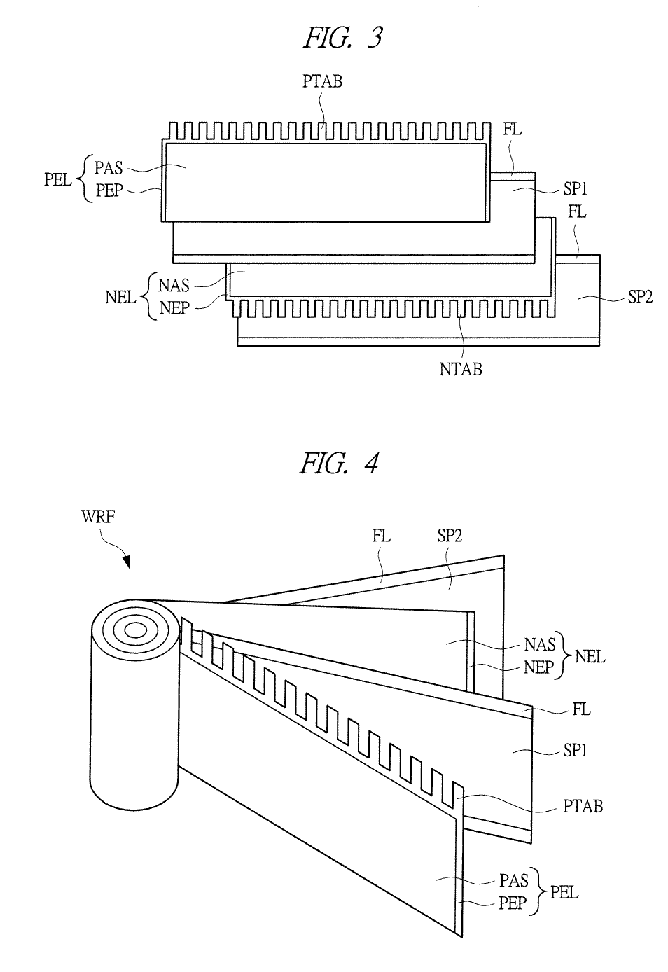

Next, a detailed configuration of the electrode-wound body will be described. FIG. 3 is a view illustrating components in a previous stage, which configure the electrode-wound body. In FIG. 3, the components configuring the electrode-wound body according to the first embodiment are the positive electrode PEL, the separator SP1, the negative electrode NEL, and the separator SP2. At this time, the positive electrode PEL has a structure in which the positive-electrode active substance PAS is coated on both surfaces of the positive-electrode plate PEP, and the negative electrode NEL has a structure in which the negative-electrode active substance NAS is coated on both surfaces of the negative-electrode plate NEP. And, on a top side of the positive electrode PEL, the plurality of rectangular positive-electrode collecting tabs PTAB are formed. Similarly, on a bottom side of the negative electrode NEL, the plurality of rectangular negative-electrode collecting tabs NTAB are formed. Further, on each end portion of the separator SP1 and the separator SP2, a filler FL made of an insulating material is coated. Here, a feature of the first embodiment lies in a point that the filler FL is coated on the end portions of the separator SP1 and the separator SP2. In this manner, when the positive electrode PEL, the separator SP1, the negative electrode NEL, and the separator SP2 are wound, for example, an end portion of a space formed between the positive electrode PEL and the separator SP1 and an end portion of a space formed between the separator SP1 and the separator SP2 adjacent to each other can be closed by the filler FL. As a result, by the filler FL, the entering of the foreign substance (more particularly, metal foreign substance) into the electrode-wound body can be prevented.

More specifically, a configuration of the electrode-wound body WRF according to the first embodiment will be described. FIG. 4 is a schematic view illustrating a state that the electrode-wound body WRF is formed by winding the positive electrode PEL, the separator SP1, the negative electrode NEL, and the separator SP2. As illustrated in FIG. 4, the positive electrode PEL, the separator SP1, the negative electrode NEL, and the separator SP2 are wound such that the separator SP1 is sandwiched between the positive electrode PEL and the negative electrode NEL and the negative electrode NEL is sandwiched between the separator SP1 and the separator SP2. At this time, while the positive-electrode collecting tabs PTAB formed in the positive electrode PEL are arranged on a top portion side of the electrode-wound body WRF, the negative-electrode collecting tabs NTAB formed in the negative electrode NEL are arranged on a bottom portion side of the electrode-wound body WRF.

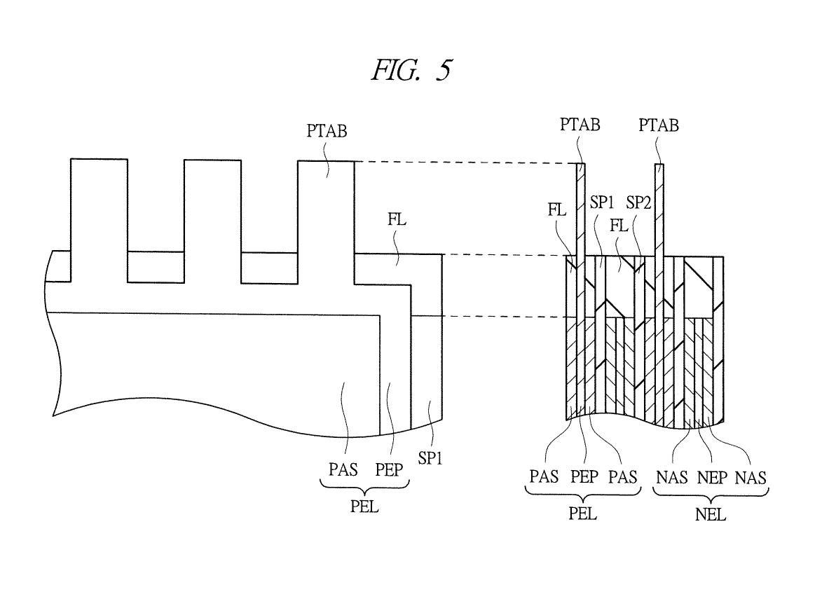

FIG. 5 is an enlarged view illustrating a part of the electrode-wound body WRF according to the first embodiment. A view on a left side of FIG. 5 is an enlarged view illustrating a vicinity of a top end portion of the positive electrode PEL in a circumferential direction of the electrode-wound body WRF, and a view on a right side of FIG. 5 is a cross-sectional view cut in a diametrical direction of the electrode-wound body WRF. First, as illustrated in the view on the left side of FIG. 5, the positive electrode PEL has a configuration in which the positive-electrode active substance PAS is coated on the positive-electrode plate PEP, and the plurality of positive-electrode collecting tabs PTAB are formed on a top end portion of the positive-electrode plate PEP. And, the separator SP1 is arranged in contact with a rear surface (back surface) of the positive electrode PEL. The filler FL is coated on a top end portion of the separator SP1.

Subsequently, as illustrated in the view on the right side of FIG. 5, the separator SP1 is arranged between the positive electrode PEL and the negative electrode NEL, and the separator SP1 and the separator SP2 are arranged so as to sandwich the negative electrode NEL. Therefore, it is found out that the separator SP 1 or the separator SP2 is arranged between the positive electrode PEL and the negative electrode NEL, and the positive electrode PEL and the negative electrode NEL are electrically insulated from each other by the separator SP1 or the separator SP2. And, the electrolyte solution is filled between the positive electrode PEL and the negative electrode NEL.

Here, the top end portion of the negative electrode NEL is the lowest on the top end portion side of the positive electrode PEL, and the top end portions of the separator SP1 and the separator SP2 are arranged higher than that of the negative electrode NEL. And, the positive-electrode collecting tabs PTAB of the positive electrode PEL are protruded up to a position higher than the top end portions of the separator SP1 and the separator SP2. At this time, as illustrated in the view on the right side of FIG. 5, the filler FL is coated on the top end portions of the separator SP1 and the separator SP2, so that an end portion of the space formed between the separator SP1 and the separator SP2 is filled by the filler FL, and beside, end portions of spaces formed between the positive electrode PEL and the separator SP1 and between the positive electrode PEL and the separator SP2 are also filled by the filler FL. Since the top end portion of the negative electrode NEL is formed lower than the top end portions of the separator SP1 and the separator SP2, the top end portion of the negative electrode NEL is covered by the filler FL coated on the top end portions of the separator SP1 and the separator SP2. In this manner, an inside of the electrode-wound body WRF filled by the electrolyte solution is closed by the filler FL. Therefore, according to the first embodiment, the top end portion of the electrode-wound body WRF is closed by the filler FL, and therefore, the entering of the metal foreign substance into the electrode-wound body WRF can be suppressed.

For example, if the metal foreign substance enters into the electrode-wound body WRF, an internal short circuit may occur between the positive electrode PEL and the negative electrode NEL. More specifically, a state that the metal foreign substance enters into the electrode-wound body WRF means a state that the metal foreign substance enters into spaces formed between the positive-electrode plate PEP and the separator SP1 and between the negative-electrode plate NEP and the separator SP1. In a case that the metal foreign substance is copper, when the copper entering into the space adheres on the positive electrode PEL, the copper is oxidized (electrons are taken out) by a high potential of the positive electrode PEL, and is dissolved as metal ions in the electrolyte solution. And, when the metal ions reach the negative electrode NEL, the metal ions are reduced (electrons are supplied), and is deposited as the metal (copper) on the negative electrode NEL. In such a mechanism, by continuing the deposition of the metal on the negative electrode NEL, the metal grown on the negative electrode NEL is passed through the pores of the separator SP1 to reach the positive electrode PEL, and thus, the internal short circuit occurs between the positive electrode PEL and the negative electrode NEL via the deposited metal. On the other hand, in a case that the metal foreign substance is aluminum, the phenomenon of dissolution and deposition due to the oxidation-reduction reaction does not occur. However, when a size of the entering metal foreign substance is large, the metal foreign substance (aluminum) breaks through the separator SP1 to cause the internal short circuit between the positive electrode PEL and the negative electrode NEL. Once the short circuit occurs between the positive electrode PEL and the negative electrode NEL, they do not function as the lithium-ion battery. Thus, it is found out that, in the lithium-ion battery, the internal short circuit may occur between the positive electrode PEL and the negative electrode NEL by the entering of the metal foreign substance into spaces formed between the positive electrode PEL and the separator SP1 and between the negative electrode NEL and the separator SP1.

Accordingly, in the first embodiment, by coating the filler FL on the top end portions of the separator SP1 and the separator SP2, the inside of the electrode-wound body WRF filled by the electrolyte solution is closed by the filler FL. In this manner, according to the first embodiment, the top end portion of the electrode-wound body WRF is closed by the filler FL, and therefore, the entering of the metal foreign substance into the electrode-wound body WRF can be suppressed, and as a result, the internal short circuit between the positive electrode PEL and the negative electrode NEL in the lithium-ion battery can be suppressed.

Note that FIG. 5 describes the filling structure on the positive electrode PEL side. However, also on the bottom portion side (negative electrode NEL side) of the electrode-wound body WRF, the same filling structure as that on the positive electrode PEL side can be used. More specifically, FIG. 6 is an enlarged view illustrating a part of the electrode-wound body WRF according to the first embodiment. A view on a left side of FIG. 6 is an enlarged view illustrating a vicinity of a bottom end portion of the negative electrode NEL in a circumferential direction of the electrode-wound body WRF, and a view on a right side of FIG. 6 is a cross-sectional view cut in a diametrical direction of the electrode-wound body WRF. First, as illustrated in the view on the left side of FIG. 6, the negative electrode NEL has a configuration in which the negative-electrode active substance NAS is coated on the negative-electrode plate NEP, and the plurality of negative-electrode collecting tabs NTAB are formed on a bottom end portion of the negative-electrode plate NEP. And, the separator SP2 is arranged in contact with a rear surface (back surface) of the negative electrode NEL. The filler FL is coated on a bottom end portion of the separator SP2.

Subsequently, as illustrated in the view on the right side of FIG. 6, the separator SP1 is arranged between the positive electrode PEL and the negative electrode NEL, and the separator SP1 and the separator SP2 are arranged so as to sandwich the negative electrode NEL. Therefore, it is found out that the separator SP1 or the separator SP2 is arranged between the positive electrode PEL and the negative electrode NEL, and the positive electrode PEL and the negative electrode NEL are electrically insulated from each other by the separator SP1 or the separator SP2. And, the electrolyte solution is filled between the positive electrode PEL and the negative electrode NEL.

Here, the bottom end portion of the positive electrode PEL is the highest on the bottom end portion side of the negative electrode NEL, and the bottom end portions of the separator SP1 and the separator SP2 are arranged lower than that of the positive electrode PEL. And, the negative-electrode collecting tabs NTAB of the negative electrode NEL are protruded down to a position lower than the bottom end portions of the separator SP1 and the separator SP2. At this time, as illustrated in the view on the right side of FIG. 6, the filler FL is coated on the bottom end portions of the separator SP1 and the separator SP2, so that an end portion of a space formed between the separator SP1 and the separator SP2 is filled by the filler FL, and beside, end portions of spaces formed between the negative electrode NEL and the separator SP1 and between the negative electrode NEL and the separator SP2 are also filled by the filler FL. Since the bottom end portion of the positive electrode PEL is formed higher than the bottom end portions of the separator SP1 and the separator SP2, the bottom end portion of the positive electrode PEL is covered by the filler FL coated on the bottom end portions of the separator SP1 and the separator SP2. In this manner, an inside of the electrode-wound body WRF filled by the electrolyte solution is closed by the filler FL. Therefore, according to the first embodiment, the bottom end portion of the electrode-wound body WRF is closed by the filler FL, and therefore, the entering of the metal foreign substance into the electrode-wound body WRF can be suppressed.

As described above, in the first embodiment, both the top end portion and the bottom end portion of the electrode-wound body WRF are closed by the filler FL, and therefore, the entering of the metal foreign substance into the electrode-wound body WRF can be effectively suppressed. However, even if both the top end portion and the bottom end portion of the electrode-wound body WRF are not closed by the filler FL unlike the first embodiment, some degree of the entering of the metal foreign substance can be suppressed. For example, only the top end portion of the electrode-wound body WRF may be closed by the filler FL, or only the bottom end portion of the electrode-wound body WRF may be closed by the filler FL. More particularly, it is considered that the metal foreign substance entering into the electrode-wound body WRF moves downward often, and therefore, the configuration in which the top end portion of the electrode-wound body WRF is closed by the filler FL is desirable from a viewpoint of preventing the entering of the metal foreign substance into the electrode-wound body WRF.

A feature of the first embodiment lies in a point that the end portion of the electrode-wound body WRF is closed by the filler FL, and by using this configuration, the entering of the metal foreign substance into the electrode-wound body WRF can be prevented. That is, it is found out that, since the entering of the metal foreign substance into the electrode-wound body WRF can be suppressed after the end portion of the electrode-wound body WRF is closed by the filler FL, it is effective to close the end portion of the electrode-wound body WRF by the filler FL as early as possible for preventing the entering of the metal foreign substance.

For example, steps of manufacturing the lithium-ion battery includes: a step of winding the positive electrode PEL and the negative electrode NEL; a step of welding and fixing the electrode-wound body WRF to the packaging case; a step of injecting the electrolyte solution into the packaging case; and others. In the step of winding the positive electrode PEL and the negative electrode NEL, when the positive electrode PEL and the negative electrode NEL are wound, metal powder may occur. Also, in the step of welding and fixing the collecting tabs to the collecting ring, when the collecting tabs are welded, the metal foreign substance may disperse. Further, in the step of injecting the electrolyte solution into the packaging case, the metal foreign substance mixed in the electrolyte solution may enter into the electrode-wound body WRF. Therefore, the steps of manufacturing the lithium-ion battery have a potential (latent possibility) such as mixture of the metal foreign substance into the electrode-wound body WRF in various steps. That is, while it is necessary to prevent the entering of the metal foreign substance into the electrode-wound body WRF after the lithium-ion battery is completed, it is important to prevent the mixture of the metal foreign substance in the manufacturing steps because there is a high possibility that the mixture of the metal foreign substance occurs in the steps of manufacturing the lithium-ion battery as described above.

Accordingly, the first embodiment particularly uses an artifice by which the entering of the metal foreign substance into the electrode-wound body WRF can be prevented as early as possible in the manufacturing steps. Hereinafter, steps of manufacturing the lithium-ion battery according to the first embodiment in which the artifice is used will be described with reference to the drawings.

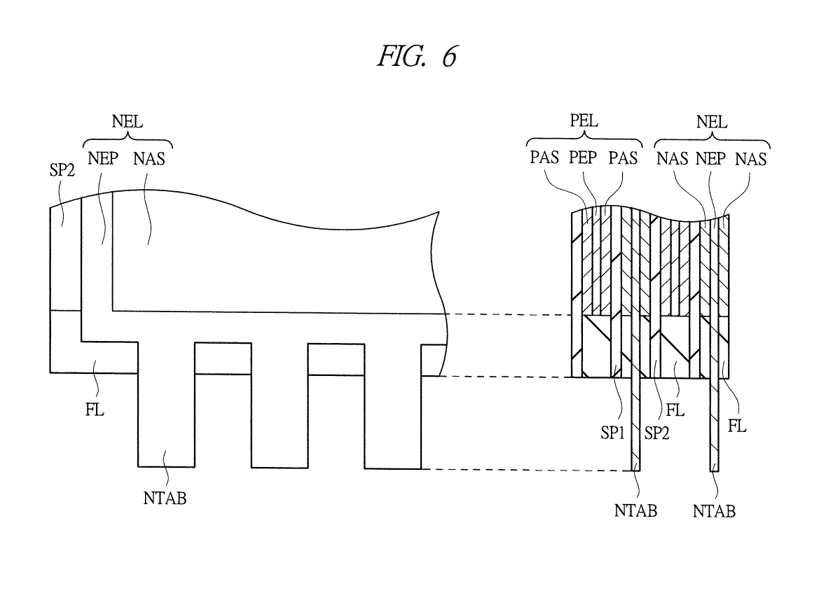

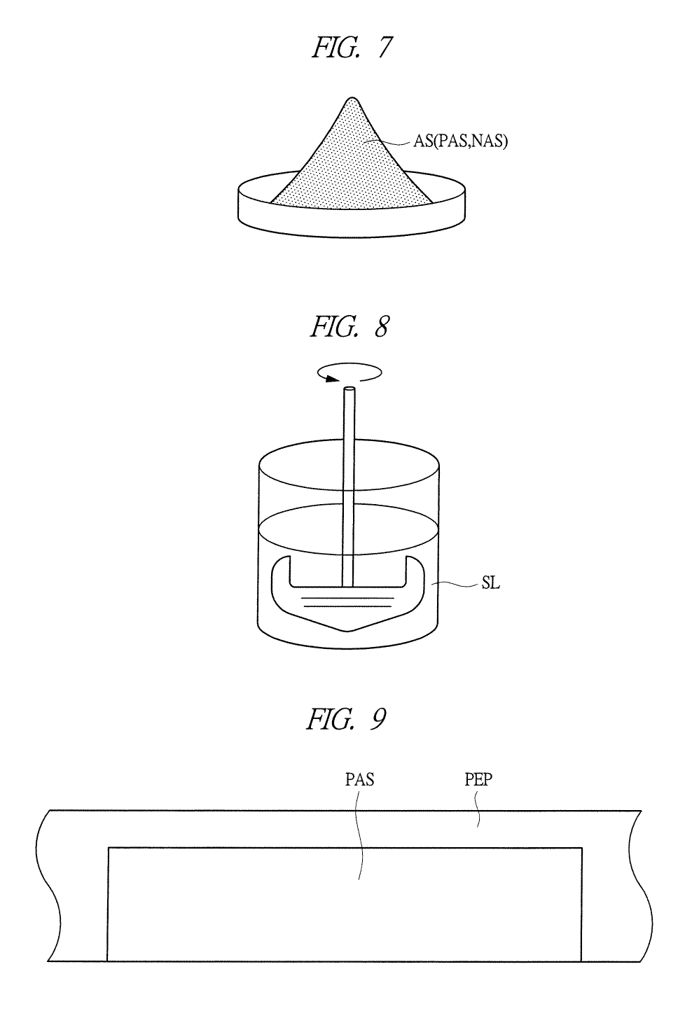

First, a step of forming the positive electrode PEL will be described. As illustrated in FIG. 7, the positive-electrode active substance PAS (active substance AS) is produced. And, as illustrated in FIG. 8, by dissolving the produced positive-electrode active substance PAS and a binder into a solution, a coating liquid (slurry) SL containing the positive-electrode active substance PAS and the binder is formed. Then, as illustrated in FIG. 9, the coating liquid SL containing the positive-electrode active substance PAS and the binder is coated on the positive-electrode plate (positive-electrode collecting body) PEP and is dried, and then, is pressured. In this manner, a high density of the positive-electrode active substance PAS coated and adhered on the positive-electrode plate PEP can be achieved.

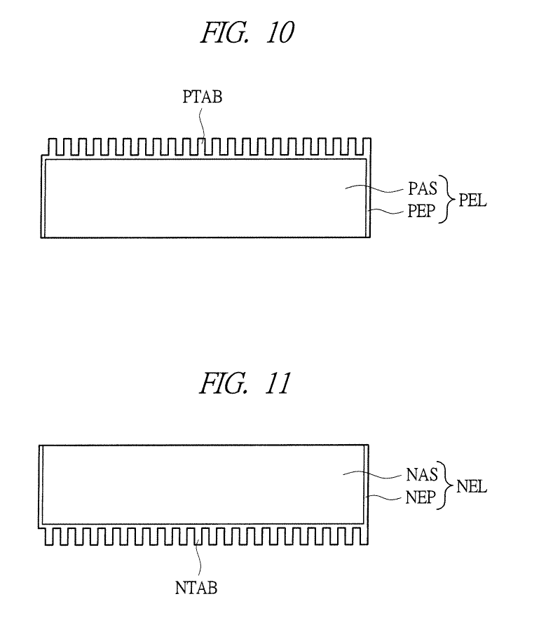

Subsequently, as illustrated in FIG. 10, the positive-electrode plate PEP on which the positive-electrode active substance PAS is coated and adhered is cut and worked. In this manner, the plurality of positive-electrode collecting tabs PTAB each having a rectangular shape can be formed along one side (top side) of the positive-electrode plate PEP. As described above, the positive electrode PEL in which the positive-electrode active substance PAS is coated and adhered on the positive-electrode plate PEP and is worked can be formed.

Next, a step of forming the negative electrode NEL will be described. A basic step in the step of forming the negative electrode NEL is the same as that of forming the positive electrode PEL. More specifically, as illustrated in FIG. 7, the negative-electrode active substance NAS (active substance AS) is produced. And, as illustrated in FIG. 8, by dissolving the produced negative-electrode active substance NAS and a binder into a solution, a coating liquid (slurry) SL containing the negative-electrode active substance NAS and the binder is formed. Then, the coating liquid SL containing the negative-electrode active substance NAS and the binder is coated on the negative-electrode plate (negative-electrode collecting body) NEP and is dried, and then, is pressured. In this manner, a high density of the negative-electrode active substance NAS coated and adhered on the negative-electrode plate NEP can be achieved.

Subsequently, the negative-electrode plate NEP on which the negative-electrode active substance NAS is coated and adhered is cut and worked. In this manner, the plurality of negative-electrode collecting tabs NTAB each having a rectangular shape can be formed along one side (bottom side) of the negative-electrode plate NEP. As described above, as illustrated in FIG. 11, the negative electrode NEL in which the negative-electrode active substance NAS is coated and adhered on the negative-electrode plate NEP and is worked can be formed.

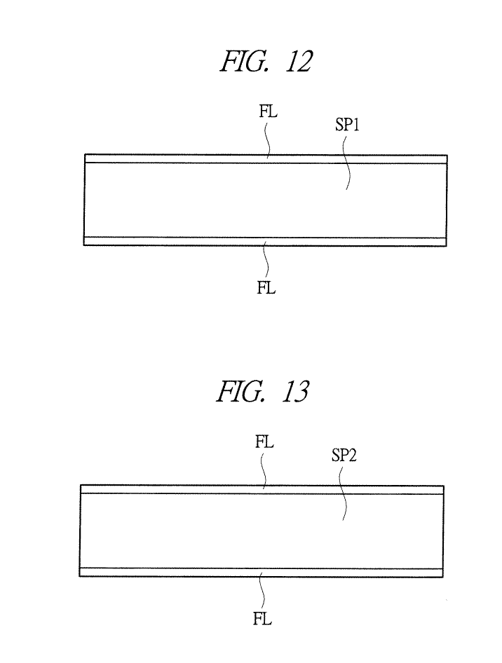

Further, as illustrated in FIGS. 12 and 13, the separator SP1 and the separator SP2 are prepared. And, the filler FL is coated on the top and bottom end portions of the separator SP1. Similarly, the filler FL is coated on the top and bottom end portions of the separator SP2. As described above, the positive electrode PEL, the negative electrode NEL, the separator SP1, and the separator SP2 can be prepared.

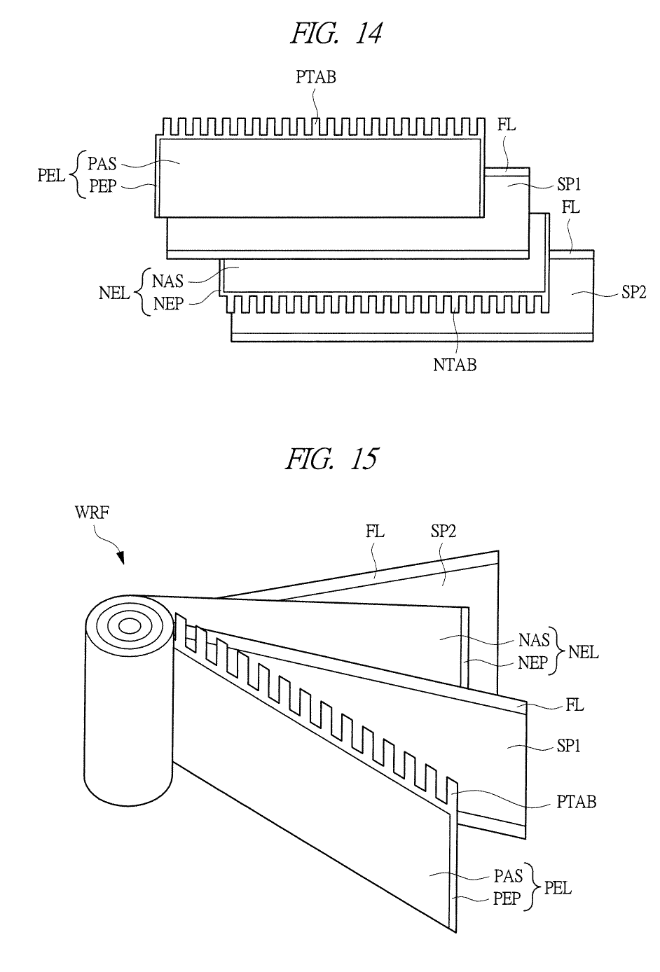

Next, as illustrated in FIG. 14, the positive electrode PEL, the negative electrode NEL, the separator SP1, and the separator SP2 are stacked so that the negative electrode NEL is sandwiched between the separator SP2 and the separator SP1 and the positive electrode PEL is arranged on the separator SP1. At this time, the positive-electrode collecting tabs PTAB formed on the positive electrode PEL and the negative-electrode collecting tabs NTAB formed on the negative electrode NEL are oppositely arranged to each other.

Then, as illustrated in FIG. 15, the electrode-wound body WRF is formed by winding the positive electrode PEL, the negative electrode NEL, the separator SP1, and the separator SP2, which are stacked. By this step, for example, as illustrated in FIGS. 5 and 6, both the top end portion and the bottom end portion of the electrode-wound body WRF are closed by the filler FL. In this manner, in the first embodiment, since the filler FL is coated on the top end portions and the bottom end portions of the separator SP1 and the separator SP2, and then, they are wound, so that the top end portion and the bottom end portion of the electrode-wound body WRF can be closed by the filler FL. That is, in the first embodiment, at the same time as the electrode-wound body WRF is formed, the top end portion and the bottom end portion of the electrode-wound body WRF can be closed by the filler FL. Therefore, after the electrode-wound body WRF is formed, the entering of the metal foreign substance into the electrode-wound body WRF can be prevented. That is, in the first embodiment, the top end portion and the bottom end portion of the electrode-wound body WRF have already been closed by the filler FL at forming the electrode-wound body WRF, and therefore, the entering of the metal foreign substance into the electrode-wound body WRF can be effectively suppressed. More particularly, although the metal powder may occur due to the pressure caused by the winding, the top end portion and the bottom end portion of the electrode-wound body WRF can be closed by the filler FL at the winding in the first embodiment. Therefore, the entering of the metal powder into the electrode-wound body WRF can be prevented.

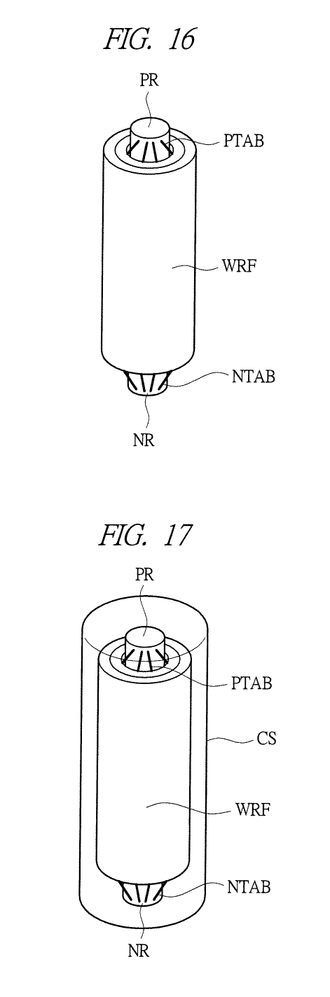

Subsequently, as illustrated in FIG. 16, the positive-electrode collecting tabs PTAB protruding from the top end portion of the electrode-wound body WRF are connected to the positive-electrode collecting ring PR. Similarly, the negative-electrode collecting tabs NTAB protruding from the bottom end portion of the electrode-wound body WRF are connected to the negative-electrode collecting ring NR. Here, the connection of the positive-electrode collecting tabs PTAB to the positive-electrode collecting ring PR and the connection of the negative-electrode collecting tabs NTAB to the negative-electrode collecting ring NR are performed by, for example, welding. Therefore, in a conventional technique, the metal foreign substance is dispersed at the welding, and enters into the electrode-wound body WRF. However, in the first embodiment, the entering of the metal foreign substance into the electrode-wound body WRF caused at the welding can be prevented because the top end portion and the bottom end portion of the electrode-wound body WRF have already been closed by the filler FL at the welding.

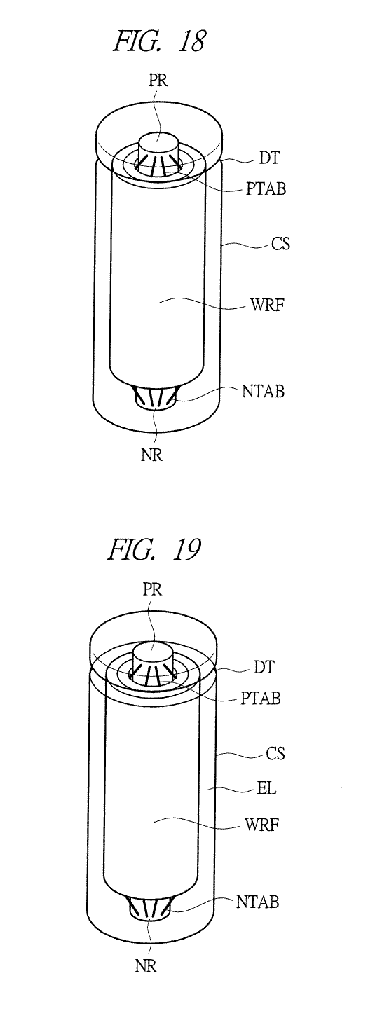

Next, as illustrated in FIG. 17, the electrode-wound body WRF is inserted into the packaging case CS. And, as illustrated in FIG. 18, the packaging case CS is worked to form a groove DT. The groove DT is provided to fix the electrode-wound body WRF inserted inside the packaging case CS so as not to move up and down. Also in this step, since the packaging case CS made of a metal material is worked, the metal foreign substance may occur. However, in the first embodiment, since the top end portion and the bottom end portion of the electrode-wound body WRF have already been closed by the filler FL, the entering of the metal foreign substance into the electrode-wound body WRF can be suppressed.

And, as illustrated in FIG. 19, the electrolyte solution EL is injected into the packaging case CS to which the electrode-wound body WRF has been inserted. At this time, even if the metal foreign substance is mixed in the electrolyte solution EL, the entering of the metal foreign substance into the electrode-wound body WRF can be prevented because the top end portion and the bottom end portion of the electrode-wound body WRF are closed by the filler FL. Note that the filler FL used in the first embodiment is made of a material having a foreign-substance filtering function to allow the electrolyte solution EL to pass through the filler and block the entering of the metal foreign substance. Therefore, even if the top end portion and the bottom end portion of the electrode-wound body WRF are closed by the filler FL, the electrolyte solution EL can be injected into the electrode-wound body WRF. Then, by sealing the top portion of the packaging case CS by the cap, the lithium-ion battery according to the first embodiment can be manufactured.

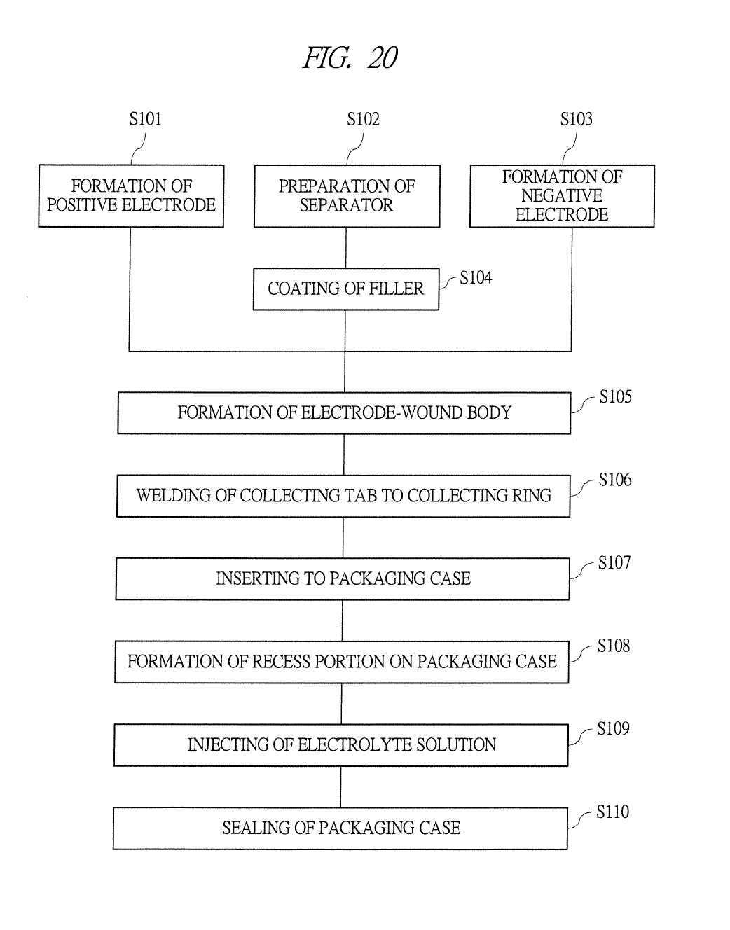

Hereinafter, the steps of manufacturing the lithium-ion battery according to the first embodiment is summarized as illustrated in FIG. 20. FIG. 20 is a flowchart illustrating a flow of the steps of manufacturing the lithium-ion battery according to the first embodiment. The flow of the manufacturing steps illustrated in FIG. 20 is described such that, first, formation of the positive electrode (S101), preparation of the separators (S102), and formation of the negative electrode (S103) are performed. And, the filler is coated on the top end portions and the bottom end portions of the prepared separators (S104). In this manner, the positive electrode, the negative electrode, and the separators on which the filler is coated can be prepared.

Next, an electrode-wound body is formed by winding the prepared positive electrode, negative electrode, and separators (S105). In this step, the top end portion and the bottom end portion of the electrode-wound body are closed by the filler. Therefore, in the subsequent steps, the entering of the metal foreign substance into the electrode-wound body can be suppressed.

And, after the collecting tabs are welded to the collecting ring (S106), the electrode-wound body is inserted into the packaging case (S107). Subsequently, after the packaging case is worked to form the groove portion (recess portion) (S108), the electrolyte solution is injected into the packaging case to which the electrode-wound body has been inserted (S109). Finally, by sealing the packaging case by the cap, the lithium-ion battery can be manufactured (S110).

A feature of the method of manufacturing the lithium-ion battery according to the first embodiment lies in a point that the winding step is performed after the filler is coated on the top end portions and the bottom end portions of the separators. In this manner, the top end portion and the bottom end portion of the electrode-wound body can be closed by the filler at forming the electrode-wound body in the winding step. In other words, in the first embodiment, by previously coating the filler on the top end portions and the bottom end portions of the separators, the top end portion and the bottom end portion of the electrode-wound body can be closed by the filler at the winding. As a result, the entering of the metal foreign substance into the electrode-wound body caused at the steps (S106 to S110) subsequent to the step of forming the electrode-wound body (S105) can be prevented. That is, in the first embodiment, by previously coating the filler on the top end portions and the bottom end portions of the separators, the entering of the metal foreign substance can be blocked at an initial stage of the formation of the electrode-wound body. This is a point of a technical idea according to the first embodiment, and is a technical idea discriminated from, for example, Patent Document 1 described in BACKGROUND.

Patent Document 1 describes a technique of, when an electrolyte solution is injected, suppressing entering of a metal foreign substance mixed in the electrolyte solution into an electrode-wound body by arranging an insulating plate having a filtering function above and away from the electrode-wound body. However, in this technique, the electrode-wound body and the insulating plate are different other units, and a step of arranging the insulating plate is a step just before the electrolyte solution is injected. Therefore, from the step of forming the electrode-wound body to the step of injecting the electrolyte solution, the metal foreign substance may enter into the electrode-wound body. That is, Patent Document 1 describes the technique only focusing on prevention of the entering of the metal foreign substance contained in the electrolyte solution, and does not aim at preventing the entering of the metal foreign substance through the whole steps of manufacturing the lithium-ion battery. That is, Patent Document 1 only focuses on the step of injecting the electrolyte solution, and therefore, the insulating plate which is the different other unit from the electrode-wound body is used, and this idea is different from the technical idea according to the first embodiment that the filler is coated on the electrode-wound body itself.

In the first embodiment, by coating the filler on the top end portions and the bottom end portions of the separators and then winding the separators, the top end portion and the bottom end portion of the electrode-wound body have already been closed by the filler at forming the electrode-wound body. This technical idea is considered by aiming at preventing the entering of the metal foreign substance through all the steps from just after the formation of electrode-wound body to the completion of the lithium-ion battery. That is, by monolithically forming the filler with the electrode-wound body, the entering of the metal foreign substance can be prevented from the formation of the electrode-wound body to the completion of the lithium-ion battery. That is, the different point is that, while the technique described in Patent Document 1 is a technique focusing on a part of the steps of manufacturing the lithium-ion battery, the technical idea according to the first embodiment considers all the steps from the formation of the electrode-wound body to the completion of the lithium-ion battery. As described above, since the focusing points of the technical ideas of Patent Document 1 and the first embodiment are different from each other, it is difficult even for those skilled in the art to easily consider the technical idea according to the first embodiment from the technique described in Patent Document 1.

Next, a detailed configuration of the filler FL used in the first embodiment will be described. As described above, it is required that the filler FL is made of a material having a foreign-substance filtering function which allows the electrolyte solution EL to pass through the filler and does not allow the metal foreign substance to pass through the same. Further, it is also required that the filler FL can be coated on the separator SP1 (SP2). As a material satisfying such conditions, there is a material called open-cell foam (porous insulating material) which is a type of plastic foam. The open-cell foam is a material that air bubbles exist in a resin and the air bubbles existing in the resin are connected with each other. By the open-cell foam, while the electrolyte solution which is liquid can be passed through the continuously-connected air bubbles, a metal foreign substance whose size is larger than those of the air bubbles cannot be passed through. Therefore, the open-cell foam is a suitable material for the filler FL in the first embodiment.

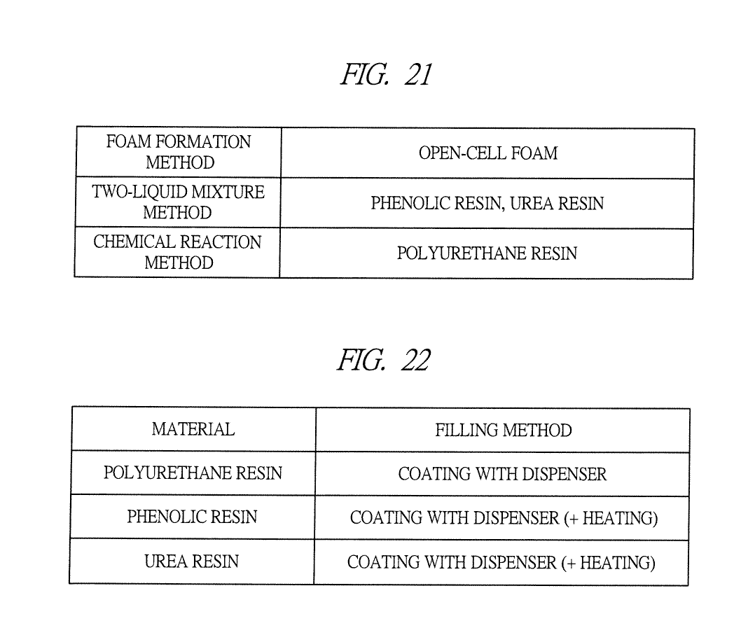

FIG. 21 is a table exemplifying materials which form the open-cell foam. More specifically, FIG. 21 shows a phenolic resin, an urea resin, and a polyurethane resin as the open-cell foam. Further, these materials can be coated on the separator SP1 (SP2). For example, as the open-cell foam formed by a two-liquid mixture method, there are the phenolic resin and the urea resin. The two-liquid mixture method is a method of forming an air-bubble structure by diffusing an evaporation-type foaming agent with using heat of reaction caused by curing of a liquid resin and curing the resin at the same time as the foaming. For example, when the evaporation-type foaming agent is added to the liquid resin containing a surfactant and they are stirred at high speed, bubble nuclei are formed in the resin liquid. By mixing a curing agent therein, the resin is cured, and swelling of the bubble nuclei formed in the resin liquid is started by the heat of reaction of the curing. The bubble nuclei are further swelled as progression of the curing of the resin, and, when the swelling reaches the maximum, the resin is solidified, so that a stable bubble structure is formed.

On the other hand, as the open-cell foam formed by a chemical reaction method, there is the polyurethane resin. The chemical reaction method is a method of causing a polymer-producing reaction by mixing, for example, a monomer, a foaming agent, a catalyst, and a surfactant and containing a gas in a resin. As described above, among the open-cell foams, the materials produced by the two-liquid mixing method or the chemical reaction method can be coated. Therefore, for example, the phenolic resin, urea resin, and polyurethane resin can be a suitable material as the filler FL according to the first embodiment.

FIG. 22 is a table showing filling methods (coating methods) in the phenolic resin, urea resin, and polyurethane resin. First, the polyurethane resin can be formed by coating with a dispenser. And, as a method of controlling a bubble diameter, an average pore diameter (bubble diameter) of the foam can be controlled to be 10 μm and 50 μm by adjusting a urethane-foam raw material.

Further, the phenolic resin can be formed by coating with a dispenser and heat treatment. And, as the method of controlling the bubble diameter, the bubble diameter can be controlled by a mixing ratio of raw materials. Also, the urea resin can be formed by coating with a dispenser and heat treatment. And, as the method of controlling the bubble diameter, the bubble diameter can be controlled by a mixing ratio of raw materials.

### Second Embodiment

The first embodiment describes the example that the filler FL is coated on the top end portion and the bottom end portion of the separator SP1 (SP2) at the stage of preparation of the separator SP1 (SP2). A second embodiment describes an example that, after forming the electrode-wound body WRF, the filler FL is coated on the top end portion and the bottom end portion of the electrode-wound body WRF by spraying.

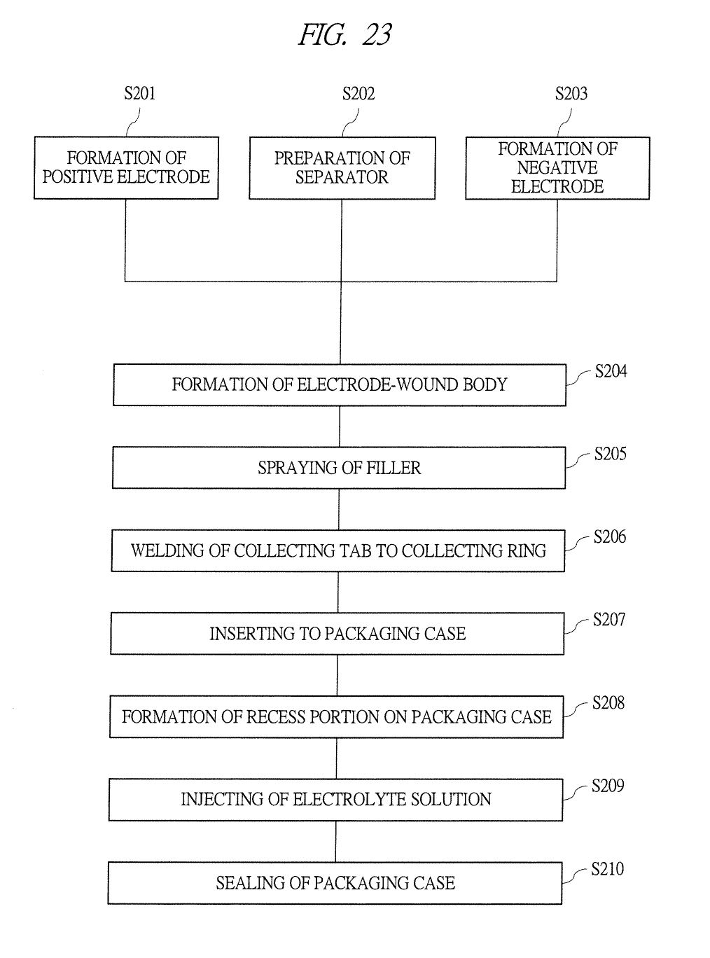

FIG. 23 is a flowchart illustrating a flow of steps of manufacturing a lithium-ion battery according to a second embodiment. The flow of the manufacturing steps illustrated in FIG. 23 is described such that, first, formation of the positive electrode (S201), preparation of the separators (S202), and formation of the negative electrode (S203) are performed.

Next, an electrode-wound body is formed by winding the prepared positive electrode, negative electrode, and separators (S204). And, the filler is formed on the top end portion and the bottom end portion of the electrode-wound body by spraying (S205). In this step, the top end portion and the bottom end portion of the electrode-wound body are closed by the filler. Therefore, in the subsequent steps, the entering of the metal foreign substance into the electrode-wound body can be suppressed.

Subsequently, after the collecting tabs are welded to the collecting ring (S206), the electrode-wound body is inserted into the packaging case (S207). Subsequently, after the packaging case is worked to form a groove portion (recess portion) (S208), the electrolyte solution is injected into the packaging case to which the electrode-wound body has been inserted (S209). Finally, by sealing the packaging case by the cap, the lithium-ion battery can be manufactured (S210).

A feature of the method of manufacturing the lithium-ion battery according to the second embodiment lies in a point that, after forming the electrode-wound body, the filler is filled on the top end portion and the bottom end portion of the electrode-wound body by spraying. In this manner, the top end portion and the bottom end portion of the electrode-wound body can be closed by the filler at a stage right after forming the electrode-wound body in the winding step. As a result, the entering of the metal foreign substance into the electrode-wound body caused at the steps (S206 to S210) subsequent to the step of forming the electrode-wound body (S204) can be prevented. That is, in the second embodiment, right after forming the electrode-wound body, by spraying the filler on the top end portion and the bottom end portion of the electrode-wound body, the entering of the metal foreign substance can be blocked at an initial stage right after the formation of the electrode-wound body.

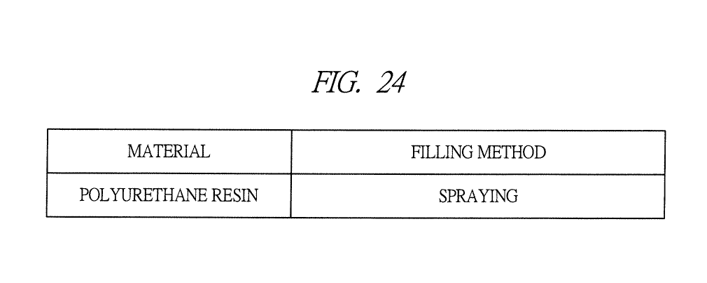

FIG. 24 is a table showing a material which can be sprayed. As seen from FIG. 24, by using the polyurethane resin as the filler, the polyurethane resin can be filled on the top end portion and the bottom end portion of the electrode-wound body by spraying.

In the foregoing, the invention made by the inventors of the present invention has been concretely described based on the embodiments. However, it is needless to say that the present invention is not limited to the foregoing embodiments and various modifications and alterations can be made within the scope of the present invention.

The present invention can be widely used for manufacturing industries of manufacturing a lithium-ion battery.

What is claimed is:

1. A lithium-ion battery comprising:
(a) a positive-electrode plate on which a positive-electrode active substance containing a lithium-containing transition metal oxide is coated;
(b) a negative-electrode plate on which a negative-electrode active substance containing a material to/from which lithium ions can be inserted and released is coated;
(c) a separator provided between the positive-electrode plate and the negative-electrode plate; and
(d) an electrolyte solution injected between the positive-electrode plate and the negative-electrode plate, and
the lithium-ion battery having the positive electrode, the separator, and the negative-electrode plate, which are wound, wherein
a filler closes an end portion of a space formed between the positive-electrode plate and the separator and an end portion of a space formed between the adjacent separators to each other.

2. The lithium-ion battery according to claim 1, wherein
the filler is an insulating material.

3. The lithium-ion battery according to claim 2, wherein
the filler is made of a material containing any one of a phenolic resin, an urea resin, and a polyurethane resin.

4. The lithium-ion battery according to claim 3, wherein
the filler is made of a porous insulating material which allows the electrolyte solution to pass through the filler.

5. A lithium-ion battery comprising:
(a) a positive-electrode plate on which a positive-electrode active substance containing a lithium-containing transition metal oxide is coated;
(b) a negative-electrode plate on which a negative-electrode active substance containing a material to/from which lithium ions can be inserted and released is coated;
(c) a separator provided between the positive-electrode plate and the negative-electrode plate; and
(d) an electrolyte solution injected between the positive-electrode plate and the negative-electrode plate, and
the lithium-ion battery having the positive electrode, the separator, and the negative-electrode plate, which are wound, wherein
a filler closes an end portion of a space formed between the negative-electrode plate and the separator and an end portion of a space formed between the adjacent separators to each other.

6. The lithium-ion battery according to claim 5, wherein
the filler is an insulating material.

7. The lithium-ion battery according to claim 6, wherein
the filler is made of a material containing any one of a phenolic resin, an urea resin, and a polyurethane resin.

8. The lithium-ion battery according to claim 7, wherein
the filler is made of a porous insulating material which allows the electrolyte solution to pass through the filler.

9. A method of manufacturing a lithium-ion battery comprising the steps of:
(a) forming a positive-electrode plate on which a positive-electrode active substance containing a lithium-containing transition metal oxide is coated;
(b) forming a negative-electrode plate on which a negative-electrode active substance containing a material to/from which lithium ions can be inserted and released is coated;
(c) preparing a separator;
(d) winding the positive-electrode plate, the separator, and the negative-electrode plate;
(e) after the step of (d), closing an end portion of a space formed between the positive-electrode plate and the separator, an end portion of a space formed between the negative-electrode plate and the separator, and an end portion of a space formed between the adjacent separators to each other by a filler;
(f) after the step of (e), inserting an electrode-wound body formed of the wounded positive-electrode plate, separator, and negative-electrode plate into a packaging case and fixing the electrode-wound body thereto;
(g) after the step of (f), injecting an electrolyte solution inside the packaging case; and
(h) after the step of (g), sealing the packaging case.

10. The method of manufacturing the lithium-ion battery according to claim 9, wherein
the filler is made of an insulating material.

11. The method of manufacturing the lithium-ion battery according to claim 10, wherein
the filler is made of a material containing any one of a phenolic resin, an urea resin, and a polyurethane resin.

12. The method of manufacturing the lithium-ion battery according to claim 11, wherein
the filler is made of a porous insulating material which allows the electrolyte solution to pass through the filler.

13. A method of manufacturing a lithium-ion battery comprising the steps of:
(a) forming a positive-electrode plate on which a positive-electrode active substance containing a lithium-containing transition metal oxide is coated;
(b) forming a negative-electrode plate on which a negative-electrode active substance containing a material to/from which lithium ions can be inserted and released is coated;
(c) preparing a separator;
(d) coating a filler on an end portion of the separator;
(e) after the step of (d), winding the positive-electrode plate, the separator, and the negative-electrode plate;
(f) after the step of (e), inserting an electrode-wound body formed of the wounded positive-electrode plate, separator, and negative-electrode plate into a packaging case and fixing the electrode-wound body thereto;
(g) after the step of (f), injecting an electrolyte solution inside the packaging case; and
(h) after the step of (g), sealing the packaging case, wherein,
in the step of (e), the filler closes an end portion of a space formed between the positive-electrode plate and the separator, an end portion of a space formed between the negative-electrode plate and the separator, and an end portion of a space formed between the adjacent separators to each other.

14. The method of manufacturing the lithium-ion battery according to claim 13, wherein
the filler is made of an insulating material.

15. The method of manufacturing the lithium-ion battery according to claim 14, wherein
the filler is made of a material containing any one of a phenolic resin, an urea resin, and a polyurethane resin.

16. The method of manufacturing the lithium-ion battery according to claim 15, wherein
the filler is made of a porous insulating material which allows the electrolyte solution to pass through the filler.
